(19) United States
(12) Patent Application Publication
(10) Pub. No.: US 2015/0362315 A1
(43) Pub. Date: Dec. 17, 2015

(54) SYSTEMS AND METHODS FOR DETERMINING POSITION INFORMATION USING ENVIRONMENTAL SENSING

(71) Applicant: InvenSense, Incorporated, San Jose, CA (US)

(72) Inventors: Behrooz Abdi, San Jose, CA (US); Ardalan Heshmati, Saratoga, CA (US); Rahul Bakshi, San Jose, CA (US)

(21) Appl. No.: 14/304,061

(22) Filed: Jun. 13, 2014

(51) Int. Cl. G01B 21/00

(52) U.S. Cl. CPC G01B 21/00

(57) ABSTRACT

Systems and methods are disclosed for determining position information for a mobile device by correlating patterns of data obtained with environmental sensors. A pattern of sensor data associated with an environmental condition may be detected at known location and then matched with a pattern of sensor data detected by the mobile device to determine position information.

### FIELD OF THE PRESENT DISCLOSURE

This disclosure generally relates to techniques for determining the position of a mobile device and more particularly to refining a coarse location using information associated with a geofeature.

### BACKGROUND

Particularly in the context of mobile devices, it is desirable to provide location awareness capabilities. An expanding variety of technologies have been developed to provide a device with information about its location, allowing it to selectively deliver information based on its location context or to otherwise adapt its operation. Common examples include navigation aids that may be used to guide a user to a desired destination, social networking applications that may inform the user about others that may be in proximity, targeted advertising schemes that may provide information relative to the user's location or tracking utilities that may provide real time information about a user's whereabouts.

In some cases, a mobile device may have position determination capabilities in the form of a Global Navigation Satellite System (GNSS), such as GPS, GLONASS, Galileo and Beidou, that, under the proper conditions, may provide precise information about the geographic location of the device. However, GNSS performance may be subject to degradation when visibility of the satellites is reduced. For example, use of GNSS in an indoor environment or obstructed outdoor environments may lengthen the time needed to obtain the necessary fix on the satellites or may prevent it entirely. Alternative means for determining the position of a mobile device that are more amenable to indoor applications may include wireless local area network (WLAN) ranging, positioning based on cellular reception, dead reckoning techniques and others. However, these alternate means may not offer the same precision as available through GNSS systems. Accordingly, there is a need for systems and methods to refine location determinations to improve accuracy or otherwise augment position information regarding a mobile device that may be used indoors as well as outdoors.

Furthermore, not all mobile devices may be equipped with GNSS systems, yet such devices may still benefit from accurate location awareness. Still further, despite the precision offered by GNSS systems, it may still be desirable to provide additional sources of position information to improve GNSS performance, such as by enhancing heading information or decreasing the time to first fix. As such it would be desirable to refine position determinations, regardless of the technique used.

This disclosure satisfies these and other needs as described in the following materials.

### SUMMARY

As will be described in detail below, this disclosure includes a method for determining position information for a mobile device associated with a user involving detecting a pattern of sensor data associated with an environmental condition at a known first location at a first time, providing a first mobile device having a sensor configured to detect an environmental condition, detecting a pattern of sensor data with the first mobile device at a second time, matching the pattern of sensor data detected by the first mobile device with the pattern of sensor data detected at the known first location and determining position information for the first mobile device using the known first location. The first time may be substantially equivalent to the second time or the second time may be subsequent to the first time. Further, matching the pattern of sensor data detected by the first mobile device with the pattern of sensor data detected at the known first location may occur at a third time that is different than the first time and the second time.

In one aspect, multiple patterns of sensor data associated with environmental conditions may be detected at known multiple locations, such that the pattern of sensor data detected by the first mobile device may be matched with the multiple patterns of sensor data detected at the known multiple locations and position information for the first mobile device may be determined using the known multiple locations. Multiple patterns of sensor data may also be detected with the first mobile device and the multiple patterns of sensor data detected by the first mobile device may be matched with the multiple patterns of sensor data detected at the known multiple locations.

In one aspect, multiple patterns of sensor data associated with different environmental conditions may be detected at the known first location, such that the multiple patterns of sensor data detected by the first mobile device may be matched with the multiple patterns of sensor data detected at the known first location.

In another aspect, detecting a pattern of sensor data associated with an environmental condition at the known first location may include detecting the pattern of sensor data with a second mobile device the known first location for the second mobile device may be determined at the first time. Alternatively, the known first location may be fixed.

In one aspect, a usage condition of the first mobile device at the first time may be determined such that the pattern of sensor data detected by the first mobile device is matched with the pattern of sensor data detected at the known first location using the determined usage condition.

In one aspect, matching the pattern of sensor data detected by the first mobile device with the pattern of sensor data detected at the known first location may be performed remotely. Further, multiple patterns of sensor data associated with environmental conditions at known multiple locations may be aggregated remotely. Additionally, the multiple patterns of sensor data associated with environmental conditions at known multiple locations may be detected by multiple mobile devices.

In one aspect, a coarse location for the mobile device may be determined independently from the pattern of sensor data detected at the known first location, such that determining position information for the first mobile device using the known first location includes refining the coarse location. Further, a pool of candidate patterns may be identified based on the coarse location, such that the pattern of sensor data detected at the known first location that is matched to the pattern of sensor data detected by the first mobile device may be selected from the pool of candidates.

In one aspect, multiple position determinations may be made for the device, wherein at least one of the multiple position determinations is based on matching the pattern of sensor data detected by the first mobile device with the pattern of sensor data detected at the known first location, a confidence level may be associated with each position determination and the multiple position determinations may be combined by weighting each determination using each respective confidence level.

This disclosure is also directed to a system for determining position information for a mobile device associated with a user. The system may include a sensor configured to detect an environmental condition, a pattern manager configured to match a pattern of sensor data detected by the sensor with a pattern of sensor data associated with an environmental condition detected at a known first location and a location manager configured to determine position information for the mobile device using the known first location. The pattern manager may also be configured to match the pattern of sensor data detected by the mobile device with multiple patterns of sensor data detected at known multiple locations, wherein the location manager is further configured to determine position information for the mobile device using the known multiple locations. Additionally, the pattern manager may match multiple patterns of sensor data detected by the mobile device with multiple patterns of sensor data detected at known multiple locations, so that the location manager may determine position information for the mobile device using the known multiple locations.

In one aspect, the system may also have multiple sensors configured to detect different environmental conditions, wherein the pattern manager matches multiple patterns of sensor data detected by the multiple sensors with multiple patterns of sensor data detected at the known first location.

In one aspect, the pattern manager may also determine a usage condition of the mobile device and match the pattern of sensor data detected by the sensor with the pattern of sensor data detected at the known first location using the determined usage condition.

In one aspect, the pattern manager may be implemented remotely. The pattern manager may also aggregate multiple patterns of sensor data associated with environmental conditions at known multiple locations. The multiple patterns of sensor data associated with environmental conditions at known multiple locations may be detected by multiple mobile devices.

In one aspect, the location manager may also determine a coarse location for the mobile device independently from the pattern of sensor data detected at the known first location and may determine position information for the mobile device using the known first location by refining the coarse location. The pattern manager may also identify a pool of candidate patterns based on the coarse location, wherein the pattern of sensor data detected at the known first location that is matched to the pattern of sensor data detected by the sensor is selected from the pool of candidates.

In one aspect, the location manager may also make multiple position determinations for the mobile device, wherein at least one of the multiple position determinations is based on matching the pattern of sensor data detected by the sensor with the pattern of sensor data detected at the known first location, may determine a confidence level associated with each position determination and may combine the multiple position determinations by weighting each determination using each respective confidence level.

In one aspect, the sensor configured to detect an environmental condition sensor data may be at least one of a thermometer, a hygrometer, a barometer, an acoustic sensor, a camera and an ambient light sensor. The environmental condition may be at least one of temperature, humidity, sound, electromagnetic radiation and atmospheric pressure.

### BRIEF DESCRIPTION OF THE DRAWINGS

FIG. 1 is a schematic map showing position information determination using environmental sensing according to an embodiment.

FIG. 2 is a schematic diagram of device configured to determine position information according to an embodiment.

FIG. 3 is a flowchart showing a routine for determining position information according to an embodiment.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the disclosure in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining.” “normalizing,” “multiplying,” “averaging,” “monitoring.” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Of course, many modifications may be made to this configuration without departing from the scope or spirit of the claimed subject matter.

The various illustrative logical blocks, modules, circuits and instructions described in connection with the embodiments disclosed herein may be executed by one or more processors, such as one or more motion processing units (MPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an MPU and a microprocessor, a plurality of microprocessors, one or more microprocessors in conjunction with an MPU core, or any other such configuration.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

According to this disclosure, one or more sensors may be configured to respond to an environmental condition and output data measuring or characterizing the condition. As used herein, “environmental condition” refers to a physical state affecting the sensor, such as temperature, humidity, sound and atmospheric pressure. In certain embodiments, a sensor for measuring an environmental condition may also be configured to react to particular wavelengths of electromagnetic radiation, such as infrared, visible and ultraviolet wavelengths, but does not include applications involving a modulated signal, such as used for wireless communication, or sensors designed to respond to the Earth's magnetic field. In addition to environmental sensors, other non-limiting examples of sensors include motion sensors, such as an accelerometer, a gyroscope and a magnetometer. In many situations, operations known as sensor fusion may involve combining data obtained from multiple sensors to improve accuracy and usefulness of the sensor data, such as by refining orientation information or characterizing a bias that may be present in a given sensor. For example, many motion tracking systems combine data from a gyroscope, an accelerometer and a magnetometer. In some embodiments, one or more sensors may be microelectromechanical systems (MEMS) based. However, the techniques of this disclosure may be applied to any sensor design or implementation.

In some embodiments, a chip may be defined to include at least one substrate typically formed from a semiconductor material. A single chip may be formed from multiple substrates, where the substrates are mechanically bonded to preserve the functionality. A multiple chip includes at least two substrates, wherein the two substrates are electrically connected, but do not require mechanical bonding. A package provides electrical connection between the bond pads on the chip to a metal lead that can be soldered to a PCB. A package typically comprises a substrate and a cover. Integrated Circuit (IC) substrate may refer to a silicon substrate with electrical circuits, typically CMOS circuits. One or more sensors may be incorporated into the package if desired using any suitable technique. In some embodiments, a sensor may be MEMS-based, such that a MEMS cap provides mechanical support for the MEMS structure. The MEMS structural layer is attached to the MEMS cap. The MEMS cap is also referred to as handle substrate or handle wafer.

In the described embodiments, an electronic device incorporating a sensor may employ a motion tracking module also referred to as Motion Processing Unit (MPU) that includes at least one sensor in addition to electronic circuits. The sensor, such as a gyroscope, a compass, a magnetometer, an accelerometer, a microphone, a pressure sensor, a proximity sensor, or an ambient light sensor, among others known in the art, are contemplated. Some embodiments include accelerometer, gyroscope, and magnetometer, which each provide a measurement along three axes that are orthogonal relative to each other referred to as a 9-axis device. Other embodiments may not include all the sensors or may provide measurements along one or more axes. The sensors may be formed on a first substrate. Other embodiments may include solid-state sensors or any other type of sensors. The electronic circuits in the MPU receive measurement outputs from the one or more sensors. In some embodiments, the electronic circuits process the sensor data. The electronic circuits may be implemented on a second silicon substrate. In some embodiments, the first substrate may be vertically stacked, attached and electrically connected to the second substrate in a single semiconductor chip, while in other embodiments, the first substrate may be disposed laterally and electrically connected to the second substrate in a single semiconductor package.

In one embodiment, the first substrate is attached to the second substrate through wafer bonding, as described in commonly owned U.S. Pat. No. 7,104,129, which is incorporated herein by reference in its entirety, to simultaneously provide electrical connections and hermetically seal the MEMS devices. This fabrication technique advantageously enables technology that allows for the design and manufacture of high performance, multi-axis, inertial sensors in a very small and economical package. Integration at the wafer-level minimizes parasitic capacitances, allowing for improved signal-to-noise relative to a discrete solution. Such integration at the wafer-level also enables the incorporation of a rich feature set which minimizes the need for external amplification.

In the described embodiments, raw data refers to measurement outputs from the sensors which are not yet processed. Motion data refers to processed raw data. Processing may include applying a sensor fusion algorithm or applying any other algorithm. In the case of a sensor fusion algorithm, data from one or more sensors may be combined to provide an orientation of the device. For example, data from a 3-axis gyroscope and a 3-axis accelerometer may be combined in a 6-axis sensor fusion and data from a 3-axis gyroscope, a 3-axis accelerometer and a 3-axis magnetometer may be combined in a 9-axis sensor fusion. In the described embodiments, an MPU may include processors, memory, control logic and sensors among structures.

This disclosure provides techniques for determining position information for a mobile device by correlating patterns of data obtained with environmental sensors. As used herein, the term “position information” means any information concerning the absolute or relative location of a device and may further include absolute or relative movement and/or orientation of the device, such as heading information. In the embodiments described below, a pattern of sensor data associated with an environmental condition detected at known location may be matched with a pattern of sensor data detected by a mobile device to determine position information for the device. The user may carry the mobile device or the device may be configured to be wearable. In the embodiments discussed below, the user is a person but these techniques may be extended to other types of users, such as animals, robots or vehicles.

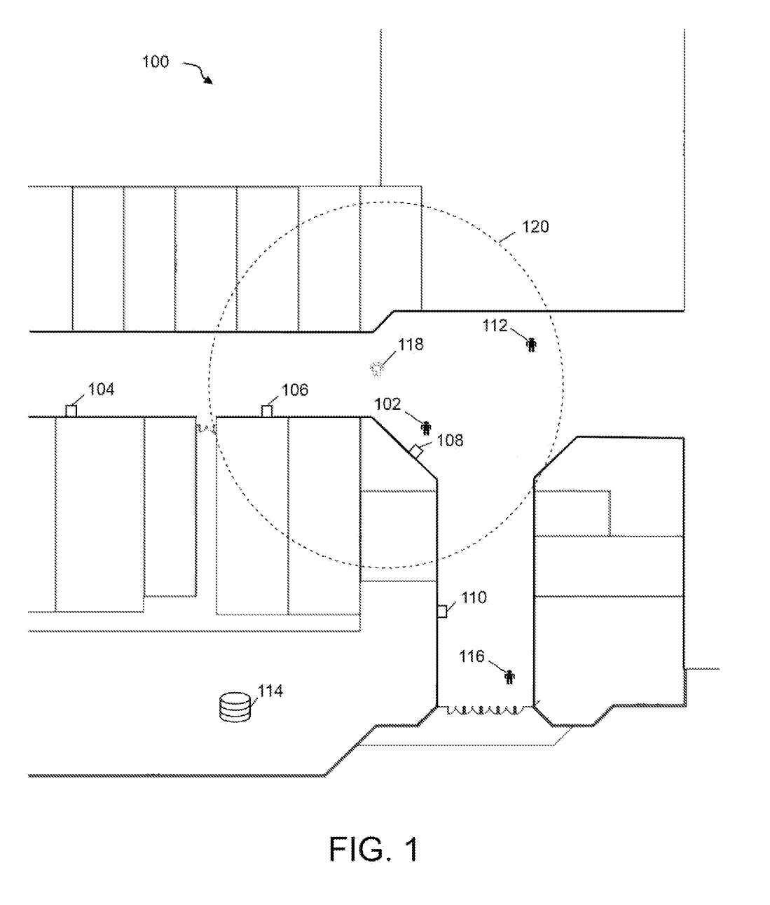

To help illustrate aspects of this disclosure, a schematic map of an indoor shopping mall 100 is depicted in FIG. 1. User 102 may have a mobile device configured to determine position information using environmental sensing according to an embodiment of this disclosure and, as such, the device may have one or more sensors configured to react to an environmental condition. Indoor shopping mall 100 may include any number of fixed environmental sensors having known locations, such as sensors 104, 106, 108 and 110. When a pattern of sensor data detected by the mobile device associated with user 102 is matched to a pattern of sensor data detected by one of the fixed environmental sensors, such as sensor 108 in this example, position information for the mobile device may be determined using the known location of sensor 108. As will be appreciated, varying tolerances or thresholds may be used when ascertaining whether patterns of sensor data match depending upon a desired confidence level for determining the position information.

In one aspect, the matching may occur substantially in real time, so that a pattern of sensor data currently being detected by sensor 108 is correlated to a pattern of sensor data currently being detected by the mobile device. As will be appreciated, sensor data may be detected over a period of time in order to be sufficiently distinguishable from sensor data detected at other known locations. Correspondingly, a pattern of sensor data detected by sensor 108 may occur over a somewhat different period than the period over which sensor data is detected by the mobile device so long as there is enough overlap to provide a match with a desired level of confidence.

In another aspect, the pattern of sensor data detected by sensor 108 and the pattern of sensor data detected by the mobile device may each be identified with a time stamp so that position information for the mobile device may be determined at a subsequent time. In a further aspect, the pattern of sensor data detected by sensor 108 may be repetitive in nature or otherwise amendable to prediction, so that the pattern of sensor data detected by the mobile device may be matched with to a pattern previously detected by sensor 108. Alternatively or in addition, sensor data detected by the mobile device at one time may be matched with a pattern extrapolated or interpolated from patterns detected by sensor 108 at other times. Similarly, any of these patterns may also be identified with time stamps to allow the matching to be performed subsequent to the detection as described above.

Position information for the mobile device may also be determined using patterns of sensor data detected at known multiple locations. For example, sensor 108 may be configured to detect one environmental condition while sensor 106 may be configured to detect another. By matching patterns of sensor data detected by the mobile device with the patterns of sensor data from both sensor 106 and sensor 108, a more robust determination of position information may be made, such as when sensor 106 and sensor 108 are within a suitable distance of each other. In another aspect, matching a pattern of sensor data detected by the mobile device with patterns of sensor detected at may include interpolating or extrapolating. For example, the pattern of sensor data detected by the mobile device may be matched by extrapolating from patterns of sensor data detected by sensor 104 and sensor 108 or by interpolating from patterns of sensor data detected by sensor 106 and sensor 110 to determine position information for user 102 in the context illustrated in FIG. 1. Although shown as occupying separate locations, any number of sensors of any type may be collocated, such as being integrated into a single device. Still further, any number of sensors may implemented in a System On a Chip (SOC) or other single package architecture.

In another embodiment, position information for the mobile device may be determined by matching multiple patterns of sensor data associated with different environmental conditions detected at a known location with multiple patterns of sensor data detected by the mobile device. For example, sensor 108 may detect multiple environmental conditions, such as sound and temperature, allowing matching with corresponding patterns detected by the mobile device to increase the confidence of the position information determination.

Although the patterns of sensor data associated with an environmental condition detected at known locations has been described above with regard to fixed location sensors 104, 106, 108 and 110, one or more such patterns may also be detected by a mobile device, such as one associated with user 112 as indicated in FIG. 1. The mobile device of user 112 may have location determination capabilities, including techniques known in the art such as GNSS, WiFi positioning, cellular tower positioning, Bluetooth™ positioning beacons, dead reckoning or other similar methods and/or may exploit the techniques of this disclosure with regard to environmental sensing. Correspondingly, the mobile device of user 112 may detect a pattern of sensor data and that pattern may be associated with the determined location.

As will be appreciated, the patterns of sensor data detected and the corresponding known locations may be communicated to the mobile device of user 102 using any suitable methods, such as wirelessly using a cellular or local area network. Alternatively or in addition, any combination of aspects related to pattern matching and position information determination may be performed remotely, such as by server 114. Although indicated as being on the premises of indoor shopping mall 100 in FIG. 1, server 114 may be located anywhere so long as sufficient communications capabilities are provided.

In a further aspect, any suitable map may be populated with one or more known locations and corresponding patterns of detected sensor data, such as those that may be provided by mobile devices having location determination capabilities. For example, server 114 may be used to store a pattern of sensor data detected by the mobile device of user 112 along with the determined location. The mobile device of user 112 may generate multiple patterns of sensor data, each having a corresponding known location as determined using the mobile device. Additional users, such as user 116, also having a mobile device with location determination capabilities may also detect patterns of sensor data associated with an environmental condition that may be aggregated into a database by server 114. These and other related crowd sourcing strategies may be used to aggregate or combine sensor data from multiple devices to establish patterns associated with known or determined locations. Alternatively or in addition, such crowd sourcing strategies may also be used to validate or improve already detected patterns.

In yet another aspect, the mobile device of user 102 may also have location determination capabilities in addition to the environmental sensing techniques of this disclosure, including any of the positioning systems described above. As such, a coarse location 118 for user 102 may be determined independently of matching patterns of environmental sensor data. Consequently, upon matching a pattern of sensor data detected by sensor 108, coarse location 118 may be refined or validated using the known location of sensor 108 to determine position information for the mobile device of user 102. Further, there may be a predicted range of uncertainty 120 associated with coarse location 118 that reflects the degree of precision of the technique used to establish the coarse location, resulting in a narrower range for a more accurate technique, such as GNSS, and a wider range for a less accurate technique, such as cellular tower positioning. As shown in FIG. 1, the predicted range of uncertainty 120 may be used to identify a pool of candidates, such as sensors 106 and 108 and the mobile device of user 112. Position information for the mobile device of user 102 may then be determined by the closest match or a match exceeding a desired threshold between a pattern detected by the mobile device with patterns detected by the candidates. In this example, the closest match may be the pattern of data detected by sensor 108, allowing position information to be determined for user 102 using the known location of sensor 108. Factors other than proximity may be used to select a pool of candidates. Heading or other context information may be used to predict likely travel paths for user 102 and, in turn, candidates may be selected based on position relative to the predicted path. Further, the mobile device of user 102 may detect a sequence of patterns, associated with the same sensor or different sensors. As such, confidence in the position determination may be increased when the sequence of patterns conforms to known conditions.

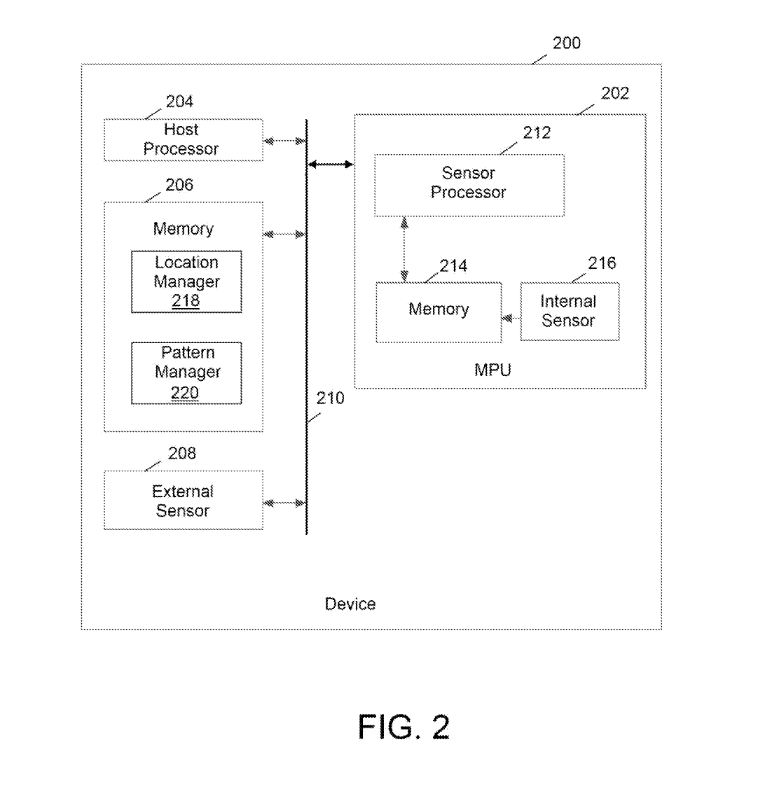

Details regarding one embodiment of a mobile electronic device 200 configured to determine position information using environmental sensing according to this disclosure are depicted as high level schematic blocks in FIG. 2. As will be appreciated, device 200 may be implemented as a device or apparatus, such as a handheld device that can be moved in space by a user and its motion and/or orientation in space therefore sensed. For example, such a handheld device may be a mobile phone (e.g., cellular phone, a phone running on a local network, or any other telephone handset), tablet, wearable device, including a health and fitness band, glasses, or the like, personal digital assistant (PDA), video game player, video game controller, navigation device, mobile internet device (MID), personal navigation device (PND), digital still camera, digital video camera, binoculars, telephoto lens, portable music, video, or media player, remote control, or other handheld device, or a combination of one or more of these devices.

As desired, device 200 may be self-contained device or may function in conjunction with another portable device or a non-portable device such as a desktop computer, electronic tabletop device, server computer, etc. which can communicate with the device 200, e.g., via network connections, such as server 114 and/or the mobile devices of users 112 and 116 as shown in FIG. 1. The device may be capable of communicating via a wired connection using any type of wire-based communication protocol (e.g., serial transmissions, parallel transmissions, packet-based data communications), wireless connection (e.g., electromagnetic radiation, infrared radiation or other wireless technology), or a combination of one or more wired connections and one or more wireless connections. Therefore, although the primary embodiments discussed in this disclosure are in the context of a self-contained device, any of the functions described as being performed by device 200 may be implemented in a plurality of devices as desired and depending on the relative capabilities of the respective devices. As an example, a wearable device may have one or more sensors that output data to another device, such as a smart phone or tablet, which may be used to perform any or all of the other functions. In yet another aspect, maintaining a database of patterns of detected sensor data and corresponding known locations as well as the pattern matching process may be performed locally by device 200 or a companion device, or remotely, such as by server 114. Thus, any combination of the involved functions may be distributed among as many local and remote devices as desired. As such, the term “system” may include either a self-contained device or a combination of devices acting in concert.

As shown, device 200 includes MPU 202, host processor 204, host memory 206, and may include one or more sensors, such as external sensor 208. Host processor 204 may be configured to perform the various computations and operations involved with the general function of device 200. Host processor 204 may be coupled to MPU 202 through bus 210, which may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, or other equivalent. Host memory 206 may include programs, drivers or other data that utilize information provided by MPU 202. Exemplary details regarding suitable configurations of host processor 204 and MPU 202 may be found in co-pending, commonly owned U.S. patent application Ser. No. 12/106,921, filed Apr. 21, 2008, which is hereby incorporated by reference in its entirety.

In this embodiment, MPU 202 is shown to include sensor processor 212, memory 214 and internal sensor 216. As used herein, the term “internal sensor” refers to a sensor implemented using the MEMS techniques described above for integration with MPU 202 into a single chip. Similarly, an external sensor as used herein refers to a sensor carried on-board device 200 that is not integrated into MPU 202. Memory 214 may store algorithms, routines or other instructions for processing data output by internal sensor 216. One or more additional internal sensors may be integrated into MPU 202 as desired. According to the techniques of this disclosure one or more of external sensor 208 and internal sensor 216 include an environmental sensor as described above. Additional sensors may include accelerometers, gyroscopes, magnetometers, or others.

As will be appreciated, host processor 204 and/or sensor processor 212 may be one or more microprocessors, central processing units (CPUs), or other processors which run software programs for device 200 or for other applications related to the functionality of device 200. For example, different software application programs such as menu navigation software, games, camera function control, navigation software, and phone or a wide variety of other software and functional interfaces can be provided. In some embodiments, multiple different applications can be provided on a single device 200, and in some of those embodiments, multiple applications can run simultaneously on the device 200. Multiple layers of software can be provided on a computer readable medium such as electronic memory or other storage medium such as hard disk, optical disk, flash drive, etc., for use with host processor 204 and sensor processor 212. For example, an operating system layer can be provided for device 200 to control and manage system resources in real time, enable functions of application software and other layers, and interface application programs with other software and functions of device 200. In some embodiments, one or more motion algorithm layers may provide motion algorithms for lower-level processing of raw sensor data provided from internal or external sensors. Further, a sensor device driver layer may provide a software interface to the hardware sensors of device 200. Some or all of these layers can be provided in host memory 206 for access by host processor 204, in memory 214 for access by sensor processor 212, or in any other suitable architecture.

In one embodiment, device 200 may include a location manager 218 implemented in memory 206 as shown, or any other suitable location or implementation, and may be configured to provide a coarse location determination for device 200. As described above, location manager 218 may employ any technique for determining coarse location, including GNSS. WiFi positioning, cellular tower positioning, Bluetooth™ positioning beacons, dead reckoning or any other similar method. As shown, device 200 also includes pattern manager 220 configured to match a pattern of sensor data detected by at least one of external sensor 208 and internal sensor 216 with a pattern of sensor data detected at a known location as described above. As such, location manager 218 may also be configured to refine position information for device 200 upon such a match using the corresponding known location.

In other embodiments, the functionality performed by the pattern manager 220 may be implemented using any combination of hardware, firmware and software and one or more functions described below as being performed by detection manager 220 may be performed remotely, as desired. For example, in one aspect, remote server 114 may maintain and patterns of sensor data associated with known locations. Device 200 may communicate a pattern of sensor data detected by external sensor 208 or internal sensor 216 to allow server 114 to match the patterns and return a corresponding known location. Alternatively or in addition, device 200 may periodically download patterns of detected sensor data having associated with known locations so that matching may be performed locally. Still further, when device 200 has sufficient location determination capabilities, pattern manager 220 may be configured to upload a pattern of sensor data detected by external sensor 208 or internal sensor 216 along with the determined location to server 114 as part of a crowd sourcing strategy.

In a further aspect, pattern manager 220 may be configured to determine a usage condition for device 200 and adjust matching operations accordingly. In this context, a usage condition is anything that may be predicted to perturb or alter the environmental sensor data. For example, if device 200 includes a transceiver, ongoing transmissions may cause an increase in temperature of the device. As another example, if device 200 is determined to be in a pocket or other enclosed location, detected sounds may be muffled or measurements of ambient light may not accurately reflect true environmental conditions. Correspondingly, depending upon the determined usage condition, pattern manager 220 may apply a compensation, defer matching to a more advantageous time or perform any other operation that may be warranted by the anticipated effect of the usage condition on the environmental sensor. In another aspect, motion sensors may be used to determine if device 200 is in a stationary usage condition. In such a condition, pattern manager 220 may sample the environmental sensor data over time to reduce measurement noise or may indicate that patterns of sensor data detected by device 200 may be used by other devices employing the environmental sensing techniques of this disclosure with a higher confidence level.

As described above, location manager 218 may use a known location associated with a matched pattern of sensor data to determine position information for device 200. In one aspect, this may include combining multiple sources of position information. For example, multiple patterns of detected sensor data may be matched, such that each pattern may be associated with a different known location. Alternatively or in addition, location manager 218 may be configured to determine a location for device 200 independently of the environmental sensing techniques of this disclosure. Making a combined position determination may include assessing a confidence level associated with each position determination and weighting each position determination using the respective confidence levels.

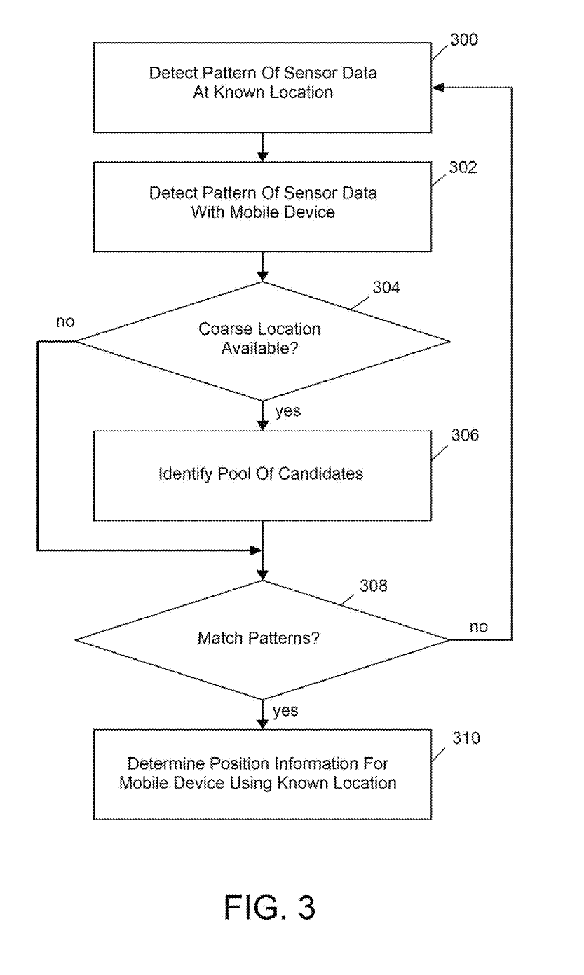

Further aspects of this disclosure are illustrated with respect to the flowchart shown in FIG. 3, which represents matching a pattern of sensor data detected by device 200 to a pattern of sensor data detected at a known location to determine position information. Beginning with 300, one or more patterns of sensor data associated with an environmental condition may be detected at one or more known locations. As described above, this may occur at fixed locations, such as indicated by sensors 104, 106, 108 and 110, or may be performed by a mobile device that is capable of determining its location, such as the mobile devices of users 112 and 116. In 302, a pattern of sensor data may be detected by device 200, such as by one or more of external sensor 208 and internal sensor 216. If a coarse location for device 200 is available, for example as provided by location manager 218 in 304, the routine may proceed to 306 to identify a pool of candidate patterns for matching based on proximity to the coarse location or other suitable criteria. In either case, the routine merges at 308 so that pattern manager 220 may determine whether a sufficient match between the pattern of sensor data detected by device 200 and a pattern of sensor data detected at a known location exists. If an adequate match is found, the routine may progress to 310 and location manager 218 may determine position information for device 200 using the known location at which the matched pattern was detected. If not, the routine returns to 300 and the process may be repeated as desired until a sufficient match is made.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A method for determining position information for a mobile device associated with a user comprising:
detecting a pattern of sensor data associated with an environmental condition at a known first location at a first time;
providing a first mobile device having a sensor configured to detect an environmental condition;
detecting a pattern of sensor data with the first mobile device at a second time;
matching the pattern of sensor data detected by the first mobile device with the pattern of sensor data detected at the known first location; and
determining position information for the first mobile device using the known first location.

2. The method of claim 1, wherein the first time is substantially equivalent to the second time.

3. The method of claim 1, wherein the second time is subsequent to the first time.

4. The method of claim 1, wherein matching the pattern of sensor data detected by the first mobile device with the pattern of sensor data detected at the known first location occurs at a third time that is different than the first time and the second time.

5. The method of claim 1, further comprising:
detecting multiple patterns of sensor data associated with environmental conditions at known multiple locations;
matching the pattern of sensor data detected by the first mobile device with the multiple patterns of sensor data detected at the known multiple locations; and
determining position information for the first mobile device using the known multiple locations.

6. The method of claim 5, further comprising detecting multiple patterns of sensor data with the first mobile device and matching the multiple patterns of sensor data detected by the first mobile device with the multiple patterns of sensor data detected at the known multiple locations.

7. The method of claim 1, further comprising:
detecting multiple patterns of sensor data associated with different environmental conditions at the known first location;
providing the first mobile device having multiple sensors configured to detect different environmental conditions;
detecting multiple patterns of sensor data with the first mobile device; and
matching the multiple patterns of sensor data detected by the first mobile device with the multiple patterns of sensor data detected at the known first location.

8. The method of claim 1, wherein detecting a pattern of sensor data associated with an environmental condition at the known first location comprises detecting the pattern of sensor data with a second mobile device, further comprising determining the known first location for the second mobile device at the first time.

9. The method of claim 1, wherein the known first location is fixed.

10. The method of claim 1, further comprising determining a usage condition of the first mobile device at the first time and matching the pattern of sensor data detected by the first mobile device with the pattern of sensor data detected at the known first location using the determined usage condition.

11. The method of claim 1, wherein matching the pattern of sensor data detected by the first mobile device with the pattern of sensor data detected at the known first location is performed remotely.

12. The method of claim 11, further comprising aggregating multiple patterns of sensor data associated with environmental conditions at known multiple locations remotely.

13. The method of claim 12, wherein the multiple patterns of sensor data associated with environmental conditions at known multiple locations are detected by multiple mobile devices.

14. The method of claim 1, further comprising determining a coarse location for the mobile device independently from the pattern of sensor data detected at the known first location, wherein determining position information for the first mobile device using the known first location comprises refining the coarse location.

15. The method of claim 14, further comprising identifying a pool of candidate patterns based on the coarse location, wherein the pattern of sensor data detected at the known first location that is matched to the pattern of sensor data detected by the first mobile device is selected from the pool of candidates.

16. The method of claim 1, further comprising making multiple position determinations for the device, wherein at least one of the multiple position determinations is based on matching the pattern of sensor data detected by the first mobile device with the pattern of sensor data detected at the known first location;
determining a confidence level associated with each position determination; and
combining the multiple position determinations by weighting each determination using each respective confidence level.

17. The method of claim 1, wherein the sensor configured to detect an environmental condition sensor data is at least one of a thermometer, a hygrometer, a barometer, an acoustic sensor, a camera and an ambient light sensor.

18. The method of claim 1, wherein the environmental condition is at least one of temperature, humidity, sound, electromagnetic radiation and atmospheric pressure.

19. A system for determining position information for a mobile device associated with a user comprising:
a sensor configured to detect an environmental condition:
a pattern manager configured to match a pattern of sensor data detected by the sensor with a pattern of sensor data associated with an environmental condition detected at a known first location; and
a location manager configured to determine position information for the mobile device using the known first location.

20. The system of claim 1, wherein the pattern manager is further configured to match the pattern of sensor data detected by the mobile device with multiple patterns of sensor data detected at known multiple locations and wherein the location manager is further configured to determine position information for the mobile device using the known multiple locations.

21. The system of claim 20, wherein the pattern manager is further configured to match multiple patterns of sensor data detected by the mobile device with multiple patterns of sensor data detected at known multiple locations and wherein the location manager is further configured to determine position information for the mobile device using the known multiple locations.

22. The system of claim 19, further comprising multiple sensors configured to detect different environmental conditions, wherein the pattern manager is further configured to match multiple patterns of sensor data detected by the multiple sensors with multiple patterns of sensor data detected at the known first location.

23. The system of claim 19, wherein the pattern manager is further configured to determine a usage condition of the mobile device and match the pattern of sensor data detected by the sensor with the pattern of sensor data detected at the known first location using the determined usage condition.

24. The system of claim 19, wherein the pattern manager is implemented remotely.

25. The system of claim 24, wherein the pattern manager is further configured to aggregate multiple patterns of sensor data associated with environmental conditions at known multiple locations.

26. The system of claim 25, wherein the multiple patterns of sensor data associated with environmental conditions at known multiple locations are detected by multiple mobile devices.

27. The system of claim 19, wherein the location manager is further configured to determine a coarse location for the mobile device independently from the pattern of sensor data detected at the known first location and to determine position information for the mobile device using the known first location by refining the coarse location.

28. The system of claim 27, wherein the pattern manager is further configured to identify a pool of candidate patterns based on the coarse location, wherein the pattern of sensor data detected at the known first location that is matched to the pattern of sensor data detected by the sensor is selected from the pool of candidates.

29. The system of claim 19, wherein the location manager is further configured to:
make multiple position determinations for the mobile device, wherein at least one of the multiple position determinations is based on matching the pattern of sensor data detected by the sensor with the pattern of sensor data detected at the known first location;
determine a confidence level associated with each position determination; and
combine the multiple position determinations by weighting each determination using each respective confidence level.

30. The system of claim 19, wherein the sensor is at least one of a thermometer, a hygrometer, a barometer, an acoustic sensor, a camera and an ambient light sensor.

31. The system of claim 19, wherein the environmental condition is at least one of temperature, humidity, sound, electromagnetic radiation and atmospheric pressure.
